(19) United States
(12) Patent Application Publication
(10) Pub. No.: US 2025/0048139 A1
(43) Pub. Date: Feb. 6, 2025

(54) WIDE-AREA MESH NETWORK

(71) Applicant: OWL INTEGRATIONS, INC., Dover, DE (US)

(72) Inventors: Bryan Knouse, Bridgewater, CT (US); Magus Pereira, Greenville, NC (US); Nick Feuer, Bridgewater, CT (US); Charlie Evans, Katy, TX (US); Taraqur Rahman, Queens, NY (US)

(21) Appl. No.: 18/923,102

(22) Filed: Oct. 22, 2024

Related U.S. Application Data
(63) Continuation of application No. 17/429,847, filed on Aug. 10, 2021, now abandoned.
(60) Provisional application No. 62/804,084, filed on Feb. 11, 2019.

(51) Int. Cl. H04W 24/02; H04W 4/12; H04W 40/38; H04W 84/18

(52) U.S. Cl. CPC H04W 24/02; H04W 4/12; H04W 40/38; H04W 84/18

(57) ABSTRACT

Techniques for deploying and using a wide-area mesh network are disclosed. A method includes: receiving, by an access point in a wide-area mesh network, a connection request from a user device; responsive to the connection request, presenting a messaging interface in a captive portal to the user device; receiving, by the access point via the messaging interface in the captive portal, a message to be transmitted over the wide-area mesh network; transmitting the message from the access point to an endpoint in the wide-area mesh network, via one or more wide-area repeaters in the wide-area mesh network; and subsequent to transmitting the message from the access point to the endpoint in the wide-area mesh network, presenting the message in a message reporting interface.

### RELATED APPLICATIONS

This application claims the benefit under 35 U.S.C. § 120 as a continuation of U.S. application Ser. No. 17/429,847, titled WIDE-AREA MESH NETWORK, filed Aug. 10, 2021, which is a U.S. National Stage Application under 35 U.S.C. § 371 of International Application No. PCT/US2020/017627, filed Feb. 11, 2020, titled WIDE-AREA MESH NETWORK, which claims the benefit under 35 U.S.C. § 119 (e) of U.S. Provisional Application No. 62/804,084, filed Feb. 11, 2019, titled DISTRIBUTED INTERNET-OF-THINGS (IOT) DEVICE NETWORK AND INCIDENT MANAGEMENT SYSTEM, each of which is hereby incorporated by reference in its entirety for all purposes.

### BACKGROUND

Many situations exist where it would be useful to transmit a message over a geographic distance, but where traditional network connectivity is difficult or nonexistent. For example, the geographic region may be very large, exceeding the transmission capacity of typical wireless devices. Power sources for networking devices may be unavailable or unreliable. Existing network topology (e.g., cellular towers) may be disrupted or offline. Some geographic locations may be difficult or dangerous to reach by land. Such situations may include, for example: disaster relief (e.g., following a flood, hurricane, earthquake, disease contagion, etc.) and/or military operations in difficult and/or contested terrain. A lack of messaging capacity in such situations may impede the timely identification and resolution of needs (e.g., transportation, supplies, and/or medical attention) at particular locations.

Approaches described in this section have not necessarily been conceived and/or pursued prior to the filing of this application. Accordingly, unless otherwise indicated, approaches described in this section should not be construed as prior art.

### SUMMARY

One or more embodiments provide a wide-area mesh network that allows for message transmission in geographic regions that are large, lack reliable power sources, are difficult and/or dangerous to reach, and/or are otherwise poorly suited to typical networking solutions. A wide-area mesh network, as described herein, may allow for the timely identification and resolution of needs (e.g., transportation, supplies, and/or medical attention) at locations covered by the wide-area mesh network. User devices may be able to access the wide-area mesh network to send messages, without requiring specialized hardware and/or software.

In general, in one aspect, a method includes: receiving, by an access point in a wide-area mesh network, a connection request from a user device; responsive to the connection request, presenting a messaging interface in a captive portal to the user device; receiving, by the access point via the messaging interface in the captive portal, a message to be transmitted over the wide-area mesh network; transmitting the message from the access point to an endpoint in the wide-area mesh network, via one or more wide-area repeaters in the wide-area mesh network; and subsequent to transmitting the message from the access point to the endpoint in the wide-area mesh network, presenting the message in a message reporting interface.

The method may further include: transmitting the message from the endpoint in the wide-area mesh network to a device that is operating outside the wide-area mesh network and configured to display the message reporting interface.

The method may further include: transmitting a response to the message from the endpoint to the access point; and presenting the response to the message in the messaging interface in the captive portal.

Transmitting the message from the access point to the endpoint in the wide-area mesh network may include: broadcasting the message from the access point to at least a first wide-area repeater and a second wide-area repeater; repeating the message over the wide-area mesh network, by the first wide-area repeater, based on a determination that a distance from the first wide-area repeater to the endpoint is not greater than a distance from the access point to the endpoint; and refraining from repeating the message over the wide-area mesh network, by the second wide-area repeater, based on a determination that a distance from the second wide-area repeater to the endpoint is greater than the distance from the access point to the endpoint.

Transmitting the message from the access point to the endpoint in the wide-area mesh network may include: broadcasting the message a first time from the access point over the wide-area mesh network; subsequent to broadcasting the message the first time, waiting a random or pseudorandom time interval; and subsequent to waiting the random or pseudorandom time interval, broadcasting the message a second time from the access point over the wide-area mesh network.

The method may further include: performing, by the access point, a text substitution to reduce a character length of the message, to reduce a number of packets needed to transmit the message without any loss of semantic meaning.

The method may further include: deploying the access point from an aircraft into a physical region comprising the wide-area mesh network.

The messaging interface may include multiple predetermined selectable messages associated with an operational purpose of the wide-area mesh network. The operational purpose may include disaster relief and the predetermined selectable messages may include at least one emergency request.

Presenting the messaging interface in the captive portal may include serving, by the access point, the messaging interface to the user device as a web page without requiring a user of the user device to specify a uniform resource locator (URL) of the web page.

The method may further include: segregating network traffic in the wide-area mesh network from other wide-area network traffic, at least by associating packets in the wide-area mesh network with a network key that is unique to the wide-area mesh network.

In general, in one aspect, one or more non-transitory machine-readable media store instructions that, when executed by the one or more processors, cause: receiving, by an access point in a wide-area mesh network, a connection request from a user device; responsive to the connection request, presenting a messaging interface in a captive portal to the user device; receiving, by the access point via the messaging interface in the captive portal, a message to be transmitted over the wide-area mesh network; and transmitting the message from the access point to an endpoint in the wide-area mesh network, via one or more wide-area repeaters in the wide-area mesh network, for presentation in a message reporting interface.

The one or more non-transitory machine-readable media may further store instructions that, when executed by one or more processors, cause: receive a response to the message from the endpoint; and presenting the response in the messaging interface in the captive portal.

The one or more non-transitory machine-readable media may further store instructions that, when executed by one or more processors, cause: receiving a network configuration message from the endpoint over the wide-area mesh network; and based at least on the network configuration message, determining a distance from the access point to the endpoint, wherein transmitting the message from the access point to the endpoint in the wide-area mesh network includes broadcasting at least one data packet including the message and the distance from the access point to the endpoint.

Transmitting the message from the access point to the endpoint in the wide-area mesh network may include: broadcasting the message a first time from the access point over the wide-area mesh network; subsequent to broadcasting the message the first time, waiting a random or pseudorandom time interval; and subsequent to waiting the random or pseudorandom time interval, broadcasting the message a second time from the access point over the wide-area mesh network.

Presenting the messaging interface in the captive portal may include serving, by the access point, the messaging interface to the user device as a web page without requiring a user of the user device to specify a uniform resource locator (URL) of the web page.

The one or more non-transitory machine-readable media may further store instructions that, when executed by one or more processors, cause: segregating network traffic in the wide-area mesh network from other wide-area network traffic, at least by associating packets in the wide-area mesh network with a network key that is unique to the wide-area mesh network.

In general, in one aspect, a system includes: an endpoint in a wide-area mesh network; one or more wide-area repeaters in the wide-area mesh network; and an access point in the wide-area mesh network, configured to: (a) receive a connection request from a user device, (b) responsive to the connection request, present a messaging interface in a captive portal to the user device, (c) receive, via the messaging interface in the captive portal, a message to be transmitted over the wide-area mesh network, and (d) transmit the message from the access point to the endpoint in the wide-area mesh network, via the one or more wide-area repeaters in the wide-area mesh network, for presentation in a message reporting interface.

The system may further include: a device that is operating outside the wide-area mesh network and configured to display the message reporting interface, the endpoint in the wide-area mesh network being configured to transmit the device that is operating outside the wide-area mesh network.

The one or more wide-area repeaters may include multiple wide-area repeaters configured to communicate using long-range (LoRa) transceivers.

One or more embodiments described in this Specification and/or recited in the claims may not be included in this General Overview section.

### BRIEF DESCRIPTION OF THE DRAWINGS

Various aspects of at least one embodiment are discussed below with reference to the accompanying Figures, which are not intended to be drawn to scale. The Figures are included to provide illustration and a further understanding of the various aspects and embodiments, and are incorporated in and constitute a part of this specification, but are not intended to define the limits of the disclosure. In the Figures, each identical or nearly identical component that is illustrated in various Figures is represented by a like numeral. For the purposes of clarity, some components may not be labeled in every figure. In the Figures:

FIG. 1 is a block diagram of an example of a wide-area mesh network according to an embodiment;

FIG. 2 is a flow diagram of an example of operations for deploying a wide-area mesh network according to an embodiment;

FIGS. 3A-3B are a flow diagram of an example of operations for communicating over a wide-area mesh network according to an embodiment;

FIG. 4 is a block diagram of an example of overlapping networks according to an embodiment;

FIG. 5 is a block diagram of an example of bridging segments of a wide-area mesh network according to an embodiment;

FIGS. 6A-6B illustrate an example of an apparatus according to an embodiment; and

FIG. 7 is a block diagram of an example of a computer system according to an embodiment.

### DETAILED DESCRIPTION

The following table of contents is provided for the reader's convenience and is not intended to define the limits of the disclosure.
1. WIDE-AREA MESH NETWORK
2. DEPLOYING A WIDE-AREA MESH NETWORK
3. COMMUNICATING OVER A WIDE-AREA MESH NETWORK
4. ADDITIONAL EXAMPLES
   4.1. OVERLAPPING NETWORKS
   4.2. BRIDING NETWORK SEGMENTS
   4.3. APPARATUS
5. MISCELLANEOUS; EXTENSIONS
6. COMPUTING DEVICES
7. COMPUTER NETWORKS

### 1. System Architecture

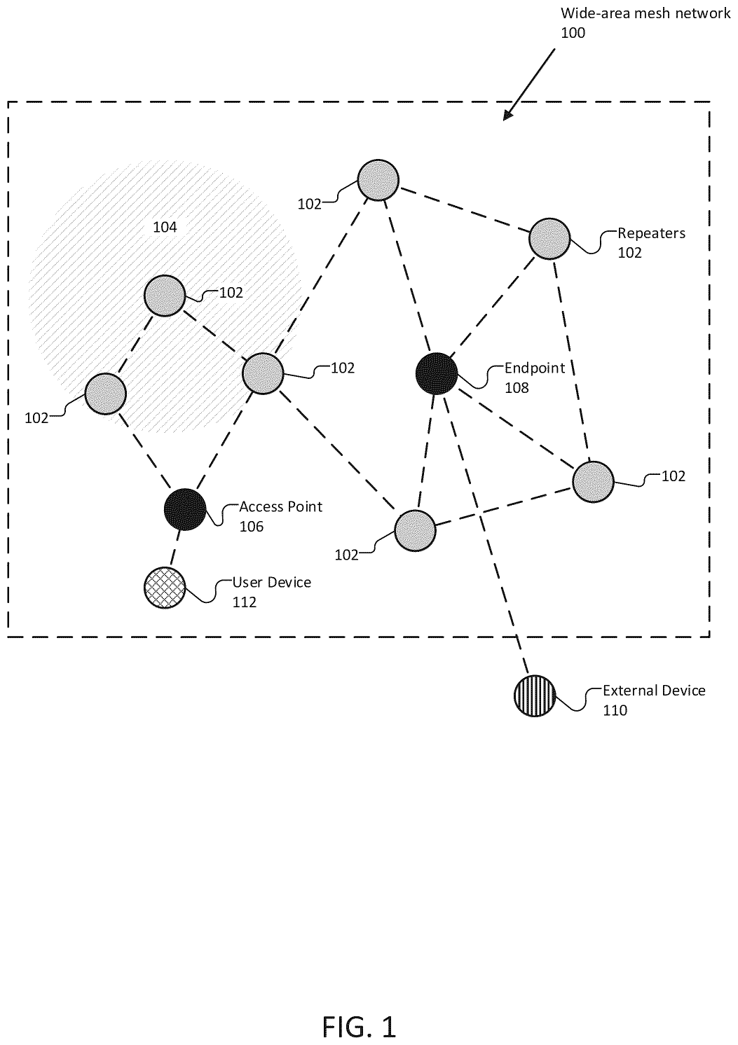

FIG. 1 is a block diagram of an example of a wide-area mesh network 100 according to an embodiment. In an embodiment, the wide-area mesh network 100 may include more or fewer components than the components illustrated in FIG. 1. Components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, the wide-area mesh network 100 includes multiple nodes physically distributed over a geographic region. The specific configuration of nodes shown in FIG. 1 is provided as an example only and should not be construed as limiting one or more embodiments. The wide-area mesh network 100 uses dynamic, non-hierarchical routing between nodes, such that no specific node topology is required to route data from one node to another. Nodes may be added or removed from the wide-area mesh network 100 and, provided that there is at least one path between two nodes, the nodes are able to exchange data. Specifically, in the wide-area mesh network 100 described herein, repeaters are able to propagate messages from an access point 106 to an endpoint 108, provided that there is a path of repeaters within range of each other between the two nodes.

In an embodiment, at least one of the nodes in the wide-area mesh network 100 is configured to operate as an access point 106 for a user device 112. For example, the access point 106 may be configured to provide a Wi-Fi hotspot, a Bluetooth® connection, and/or another form of connection to the user device 112. The user device 112 may be a mobile device (e.g., a smartphone, tablet, laptop computer, or another kind of mobile device), a desktop computer, or another kind of device. The user device 112 may be a general-purpose device that does not require any specialized hardware or software to connect to the access point 106. The wide-area mesh network 100 may thus provide cross-platform compatibility for a wide range of user devices 112 to access and use the wide-area mesh network. The wide-area mesh network 100 may include multiple access points 106 (not shown) at different physical locations.

In an embodiment, the access point 106 is configured to present a messaging interface to the user device 112. The access point 106 may be configured to present the messaging interface in a captive portal, responsive to receiving a connection request from the user device 112. For example, the access point 106 may include a web server that is configured to present the messaging interface to the user device 112 as a web page, responsive to a request from the user device 112 to connect to the access point 106. Presenting the messaging interface in a captive portal may allow a user of the user device 112 to access the messaging interface without requiring the user device 112 to include or download any specialized software application, and without requiring the user to manually specify a uniform resource locator (URL) of the messaging interface. A captive portal thus facilitates access and use of the wide-area mesh network 100, in situations where users may not be expected to have a detailed understanding of the wide-area mesh network 100 or electronics in general. Alternatively, the access point 106 may be configured to present the messaging interface to the user device 112 as a downloadable application (e.g., a smartphone, tablet, or desktop software application). The access point 106 may provide access to the messaging interface without allowing the user device 112 to access other network resources in the wide-area mesh network 100. Preventing access to other network resources may be helpful, for example, in situations where the wide-area mesh network 100 supports only low bitrates and is intended to be used primarily or exclusively for messaging.

In an embodiment, a messaging interface is a user interface that includes hardware and/or software configured to facilitate communications between a user and one or more other nodes in the wide-area mesh network 100. A user interface renders user interface elements and receives input via user interface elements. A user interface may be a graphical user interface (GUI), a command line interface (CLI), a haptic interface, a voice command interface, and/or any other kind of interface or combination thereof. Examples of user interface elements include checkboxes, radio buttons, dropdown lists, list boxes, buttons, toggles, text fields, date and time selectors, command lines, sliders, pages, and forms.

In an embodiment, different components of a user interface are specified in different languages. The behavior of user interface elements may be specified in a dynamic programming language, such as JavaScript. The content of user interface elements may be specified in a markup language, such as hypertext markup language (HTML), Extensible Markup Language (XML), or XML User Interface Language (XUL). The layout of user interface elements may be specified in a style sheet language, such as Cascading Style Sheets (CSS). Alternatively or additionally, aspects of a user interface may be specified in one or more other languages, such as Java, Python, Perl, C, C++, and/or any other language or combination thereof.

Specifically, in an embodiment, the messaging interface includes user interface components configured to allow a user of the user device 112 to select or generate a message to be transmitted to the endpoint 108. The messaging interface may include a set of pre-generated message options (e.g., “SOS,” “all clear,” “mission complete,” “send food,” “send water,” “send transportation,” “send medical assistance,” etc.). For example, the messaging interface may include a set of selectable buttons and/or dropdowns with pre-generated message options. Alternatively or additionally, the messaging interface may allow a user to provide a custom message provided by the user (e.g., typed or spoken by the user). Alternatively or additionally, the messaging interface may include a set of controls that allow a user to send messages that control devices connected to the wide-area mesh network 100. For example, one or more Internet-of-Things (IoT) devices may be connected to the wide-area mesh network 100 and configurable via messages sent over the wide-area mesh network 100. Such IoT devices may include, for example: sprinklers; cameras; door locks; alarm systems; etc.

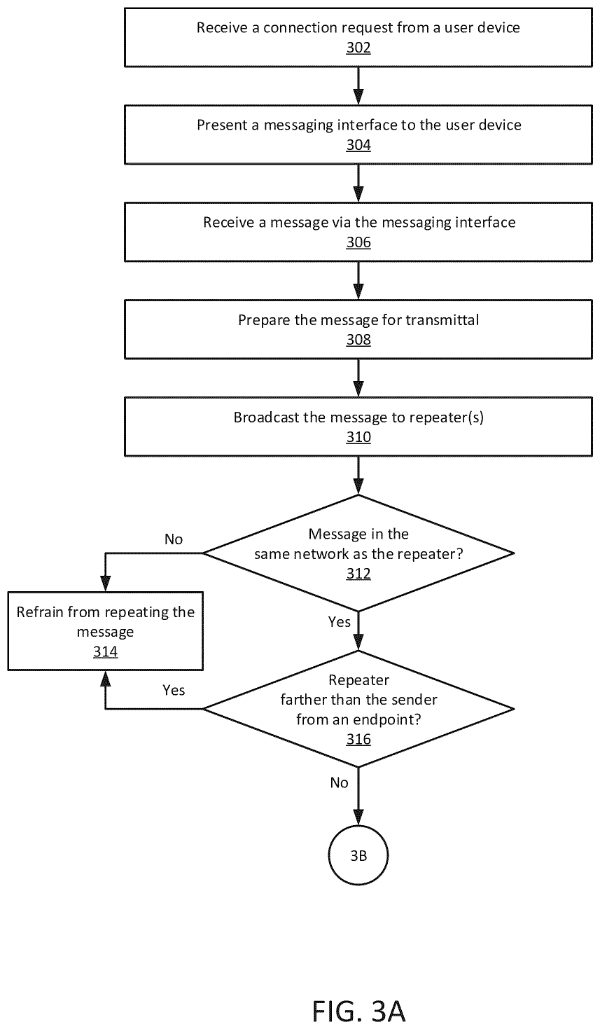

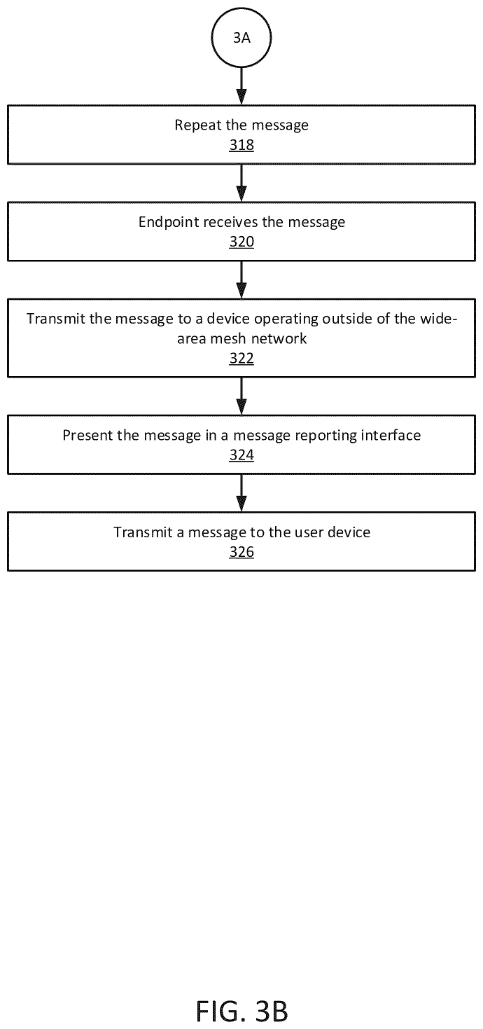

In an embodiment, the access point 106 is configured to transmit a message, selected and/or entered by a user of the user device 112 via the messaging interface, to an endpoint 108 in the wide-area mesh network 100. To transmit a message, the access point 106 may be configured to broadcast the message using a wide-area network (WAN) transmitter. For example, the access point 106 may include a LoRa (Long Range) transmitter or another kind of WAN transmitter. LoRa is a low-power WAN technology that allows for long-range transmission at relatively low bitrates, compared to other technologies that may communicate at higher bitrates but only over shorter distances. The access point 106 may also include a WAN receiver, which may be combined with the WAN transmitter as a WAN transceiver (e.g., a LoRa transceiver). An example set of operations for transmitting a message from an access point 106 to an endpoint 108 is described below with respect to FIGS. 3A-3B. One or more embodiments use a custom WAN protocol, to perform transmission and/or routing operations described herein that are not part the LoRaWAN™ specification.

In an embodiment, one or more repeaters 102 are configured to propagate the message through the wide-area mesh network 100. The example of FIG. 1 includes multiple repeaters 102 placed in different geographic locations. When using LoRa or another kind of long-range transmitter, the geographic area covered by the repeaters 102 may be very large. Each repeater 102 includes a WAN receiver and a WAN transmitter, which may be combined as a WAN transceiver (e.g., a LoRa transceiver). One or more of the repeaters 102 may also be an access point, and/or the access point 106 may also be a repeater. Each repeater 102 has a respective range 104, which defines how close the repeaters 102 need to be to propagate a message through the wide-area mesh network 100. LoRa transmitters may provide a longer range than many other kinds of WAN transmitter, and/or may allow for better penetration of obstacles (e.g., trees, buildings, rock, etc.) than many other kinds of WAN transmitter. However, the range of a particular transmitter 102 may nonetheless be limited by environmental features such as mountains, large buildings, etc.

In an embodiment, the endpoint 108 is configured to receive messages from one or more user devices 112 via one or more access points 106. The endpoint 108 may include a message reporting interface configured to present the message(s) to a user of the endpoint 108. For example, the endpoint 108 may include a display configured to present the message(s) as text and/or video, and/or a speaker configured to present the message(s) as audio. Alternatively, the endpoint 108 may be configured to transmit the message(s) to an external service 110, i.e., a service hosted by one or more devices operating outside (external to) the wide-are mesh network 100. For example, the external service 110 may be a cloud service operating in a network (e.g., the Internet) other than the wide-area mesh network 100. The endpoint 108 may be configured to transmit the message(s) to one or more devices in the external service 110 via a hardwired connection or a wireless connection (e.g., via satellite). The endpoint 108 and external service 110 may both be connected to the Internet, and the endpoint 108 may be configured to communicate with the external service 110 via the Internet.

In an embodiment, the external service 110 includes a message reporting interface, as described above. A user of the external service 110 may thus be able to review messages sent in the wide-area mesh network 100, without requiring physical access to the endpoint 108 or any other physical location in the wide-area mesh network 100. An external service 110 may be useful in situations where it is unsafe or otherwise impractical for the user to be in the physical environment covered by the wide-area mesh network 100. For example, an external service 110 may be useful if the wide-area mesh network 100 services a contested region, a disaster area, a region affected by an infectious disease, etc.

In an embodiment, one or more nodes in the wide-area mesh network 100 (e.g., an access point 106, repeater 102, and/or endpoint 108) is/are independently powered, i.e., do not require a connection to a separate power source. For example, an access point 106 may be configured to generate power using one or more solar panels. Independent power generation may allow nodes to be deployed in geographic regions where power sources are disrupted or non-existent (e.g., in a disaster area where an existing power source may be offline, a contested region where a power source may be inaccessible due to adversarial interference, or a remote region where no power source exists).

In an embodiment, one or more nodes in the wide-area mesh network 100 serve multiple purposes. Specifically, a particular node may be configured to operate as two or more of: an access point; a repeater; and/or an endpoint. A particular node may be configurable to change which operation(s) it provides, based on one or more configurable settings within the node and/or the particular physical configuration of the wide-area mesh network 100.

### 2. Deploying a Wide-Area Mesh Network

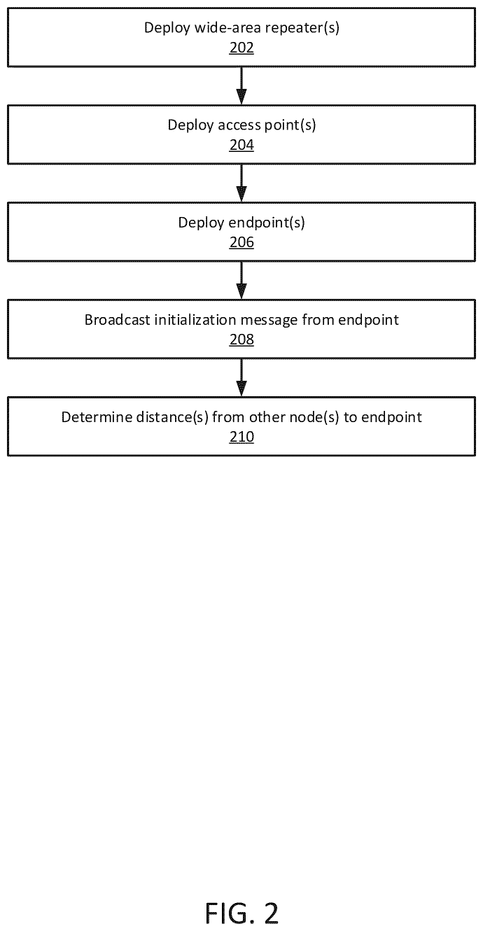

FIG. 2 is a flow diagram of an example of operations for deploying a wide-area mesh network according to an embodiment. One or more operations illustrated in FIG. 2 may be modified, rearranged, or omitted all together. Accordingly, the particular sequence of operations illustrated in FIG. 2 should not be construed as limiting the scope of one or more embodiments.

In an embodiment, one or more wide-area repeaters is/are deployed (Operation 202) in a geographic region. Each wide-area repeater may be deployed so that it is within range of at least one other repeater and/or endpoint. Wide-area repeaters may be deployed in a manner intended to provide sufficient geographic coverage for a particular purpose, e.g. a disaster relief effort or military operation. One or more wide-area repeaters may be deployed manually, i.e., by a human operator physically placing the wide-area repeater in a particular geographic location (e.g., on the ground, on top of a building, etc.). One or more wide-area repeaters may be deployed by drone, i.e., unmanned aircraft. A wide-area repeater may itself be a drone, or may be deposited in a particular location by a separate drone apparatus. One or more wide-area repeaters may be deployed by manned aircraft (e.g., an airplane or helicopter). For example, an apparatus that houses a wide-area repeater may be equipped with a parachute and dropped from a drone or manned aircraft above a particular geographic location. If a wide-area repeater requires a connection to a power source, a human operator may manually connect the wide-area repeater to the power source. If a wide-area repeater is independently powered, the wide-area repeater may begin generating power before, during, or after the deployment process.

In an embodiment, one or more access points is/are deployed (Operation 204). If an access point is also a repeater, then the access point may be deployed as described above with respect to Operation 202. In general, an access point may be deployed so that it is within range of at least one repeater and/or endpoint. An access point may be deployed manually, i.e., by a human operator physically placing the access point in a particular geographic location (e.g., on the ground, on top of a building, etc.). One or more access points may be deployed by drone, i.e., unmanned aircraft. An access point may itself be a drone, or may be deposited in a particular location by a separate drone apparatus. One or more access points may be deployed by manned aircraft (e.g., an airplane or helicopter). For example, an apparatus that houses an access point may be equipped with a parachute and dropped from a manned aircraft above a particular geographic location. If an access point requires a connection to a power source, a human operator may manually connect the access point to the power source. If an access point is independently powered, the access point may begin generating power before, during, or after the deployment process.

In an embodiment, one or more endpoints is/are deployed (Operation 206). If an endpoint is also a repeater, then the endpoint may be deployed as described above with respect to Operation 202. In general, an endpoint may be deployed so that it is within range of at least one repeater and/or access point. An endpoint may be deployed manually, i.e., by a human operator physically placing the endpoint in a particular geographic location (e.g., on the ground, on top of a building, etc.). One or more endpoints may be deployed by drone, i.e., unmanned aircraft. An endpoint may itself be a drone, or may be deposited in a particular location by a separate drone apparatus. One or more endpoints may be deployed by manned aircraft (e.g., an airplane or helicopter). For example, an apparatus that houses an endpoint may be equipped with a parachute and dropped from a manned aircraft above a particular geographic location. If an endpoint requires a connection to a power source, a human operator may manually connect the endpoint to the power source. If an endpoint is independently powered, the endpoint may begin generating power before, during, or after the deployment process.

In an embodiment, after an endpoint is deployed, it broadcasts an initialization message (Operation 208). Specifically, the endpoint transmits the initialization message over a WAN transmitter. The endpoint may transmit the initialization message in a particular direction or range of directions, or in all directions supported by the WAN transmitter. One or more repeaters in the wide-area network may receive the initialization message and propagate the initialization message to one or more other nodes in the wide-area mesh network. To avoid saturating the network, each repeater may be configured to repeat a particular initialization message a limited number of times (e.g., only once).

In an embodiment, based on the initialization message, one or more other nodes (i.e., one or more repeaters, one or more access points, and/or one or more other endpoints) in the wide-area network determine their distance(s) to the endpoint that broadcasted the initialization message (Operation 210). The distance from a node to the endpoint may be a geographic distance. For example, the initialization message may include Global Positioning System (GPS) data or other positioning data indicating a geographic location of the endpoint. When a node receives the initialization message, the node may compare its own geographic location with the geographic location in the initialization message, to determine a geographic distance between the node and the access point. Alternatively, the distance from a node to the endpoint may be a temporal distance. For example, the initialization message may include a time when the initialization message was sent (e.g., on the order of milliseconds). When a node receives the initialization message, the node may compare the time of receipt with the time in the initialization message, to determine a temporal distance between the node and the access point. Alternatively, the distance from the node to the endpoint may be a logical distance, such as a number of network hops or other metric. For example, the initialization message may include a hop counter. Each time the initialization message is repeated in the wide-area mesh network, the repeater may increment the hop counter. When a node receives the initialization message, the node may read the current value of the hop counter, to determine the logical distance between the node and the endpoint.

As described below, nodes in the wide-area mesh network may use their respective distances from the endpoint to inform routing strategies. Alternatively or additionally, one or more nodes in the wide-area mesh network may maintain routing tables that provide, at each node, a local view of the available network path(s) to the endpoint. Alternatively or additionally, one or more nodes in the wide-area mesh network may store a cache of messages (e.g., using message hashes and/or another form of unique message identifier) that the node has already sent/repeated, to avoid retransmitting the same message. To manage storage requirements, a message cache may be configured to expire after a certain period of time, e.g., a time that is sufficient to allow a message to propagate across the entire wide-area mesh network. Many different routing strategies may be used.

In an embodiment, if a new node (e.g., a new repeater and/or access point) joins the wide-area mesh network, the new node may announce its presence by broadcasting a message over the wide-area mesh network. An endpoint may be configured to broadcast a new initialization message responsive to receiving an announcement from a new node, to allow the new node to determine its distance from the endpoint and/or to allow nodes to reconfigure their local routing tables accordingly.

### 3. Communicating Over a Wide-Area Mesh Network

FIGS. 3A-3B are a flow diagram of an example of operations for communicating over a wide-area mesh network according to an embodiment. One or more operations illustrated in FIGS. 3A-3B may be modified, rearranged, or omitted all together. Accordingly, the particular sequence of operations illustrated in FIGS. 3A-3B should not be construed as limiting the scope of one or more embodiments.

In an embodiment, an access point receives a connection request from a user device (Operation 302). For example, the access point may receive a request for the user device to connect to the access point via a Wi-Fi hotspot, Bluetooth® connection, or other kind of connection.

In an embodiment, the access point presents a messaging interface to the user device (Operation 304). The access point may present the messaging interface to the user device in a captive portal, responsive to receiving a connection request from the user device. For example, the access point may include a web server that is configured to present the messaging interface to the user device as a web page, responsive to the connection request from the user device. Alternatively, the access point present the messaging interface to the user device as a downloadable application (e.g., a smartphone, tablet, or desktop software application).

In an embodiment, the access point receives a message via the messaging interface presented to the user device (Operation 306). Some examples of messages are described above with respect to FIG. 1. Before broadcasting the message over the wide-area mesh network, the access point may prepare the message for transmittal (Operation 308). For example, if the message is too large to send in a single packet, then the access point may divide the message into multiple packets. Alternatively, the access point may shorten the message so that it fits into a maximum number of packets (e.g., a single packet and/or a particular character length, such as 150 characters or less). To shorten the packet, the access point may perform text substitution on the contents of the message, without any loss of semantic meaning of the message. For example, the access point may replace words representing numbers with the numbers themselves (e.g., replace the word “one” with the numeral “1”), replace common phrases with corresponding codes (e.g., replace the phrase “message received” with the numerical code “10-4”), and/or perform another substitution or combination thereof to shorten the message. Alternatively or additionally, the access point may package metadata with the message prior to transmission. The metadata may indicate, for example, one or more of: a distance of the access point from the endpoint (e.g., determined as described above with respect to FIG. 2); a geographic location of the access point; a key that is uniquely associated with the wide-area mesh network, to help segregate traffic for multiple networks as described herein; sensor data (e.g., temperature and/or humidity) gathered by one or more sensors disposed within and/or otherwise coupled with the access point; and/or another kind of metadata or combination thereof.

In an embodiment, the access point broadcasts the message to one or more repeaters (Operation 310), by transmitting the message using a WAN transmitter. The access point may transmit the message in a particular direction or range of directions, or in all directions supported by the WAN transmitter. The access point may not be aware of any particular other node(s) that is/are within range of the access point.

In an embodiment, some messages have higher priority than others. For example, if the messaging interface provides an “SOS” message option and an “all clear” message option, the “SOS” message may have higher priority than the “all clear” message. A message priority may be included in metadata packaged with the message, and/or may be determined based on some other property of the message. Nodes in the wide-area mesh network may be configured to handle higher-priority messages differently than lower-priority messages. For example, a node (e.g., access point or repeater) may broadcast a high-priority message more than once, to help increase the likelihood of delivery. The node may broadcast the message a first time, wait a period of time (which may be a random or pseudorandom period of time, e.g., 0-2 seconds), and then broadcast the message again. Waiting a random or pseudorandom period of time may help avoid messages being broadcast at the same time, which could cause data collisions and/or corruption. Alternatively, a node may broadcast all messages more than once, regardless of priority. Alternatively, a node may broadcast each message only once.

In an embodiment, when a repeater receives the message, the repeater determine whether the message is in the same network as the repeater (Operation 312). The repeater may determine whether the message is in the same network as the repeater based on metadata packaged with the message (e.g., metadata provided by the access point, as described above). If the message is not in the same network as the repeater, then the repeater refrains from repeating the message (Operation 314). Refraining from repeating the message may help prevent one or more devices that do not belong to the wide-area mesh network (an which may be associated with a malicious actor) from flooding the wide-area mesh network with traffic that does not belong in the wide-area mesh network.

In an embodiment, the repeater determines whether it is farther than the sender (i.e., the node from which the receiver received the message) is from an endpoint (Operation 316). For example, if the repeater received the message from the access point, then the repeater determines whether it is farther than the access point from the endpoint. If the repeater received the message from another repeater, then the repeater determines whether it is farther than the other repeater from the access point. The repeater may determine whether it is farther than the sender from the endpoint based on distance information stored in metadata associated with the message. Alternatively, the repeater may determine whether it is farther than the sender from the endpoint based on a local routing table, or in some other way.

In an embodiment, if the repeater is farther than the sender from the endpoint, then the repeater refrains from repeating the message (Operation 314). Refraining from repeating the message may help ensure that the message is propagated toward the endpoint, without adding unnecessary load to repeaters that are farther away from the endpoint. In some embodiments, if the repeater is the same distance (e.g., the same number of hops) as the sender from the endpoint, then the repeater also refrains from repeating the message. Alternatively, if the repeater is the same distance (e.g., the same number of hops) as the sender from the endpoint, then the repeater may repeat the message as described below.

If the repeater is not farther away than the sender from the endpoint, then the repeater repeats the message (Operation 318). Before repeating the message, the repeater may modify metadata packaged with the message. For example, if the metadata indicates the sender's distance from the access point, the repeater may replace that value with its own distance from the access point, to help ensure that the message continues to propagate toward the access point without propagating away from it. To repeat the message, the repeater transmits the message using a WAN transmitter. The repeater may transmit the message in a particular direction or range of directions, or in all directions supported by the WAN transmitter. The repeater may not be aware of any particular other node(s) that is/are within range of the repeater.

In an embodiment, as a result of the message propagating over the wide-area mesh network, an endpoint receives the message (Operation 320). As discussed above, the endpoint may include a message reporting interface. Alternatively or additionally, the endpoint may transmit the message to an external service, i.e., one ore more devices operating outside of the wide-area mesh network (Operation 322). In an embodiment, the message is presented in a message reporting interface (Operation 324), by the endpoint or by the external service.

In an embodiment, the message reporting interface is configured to present one or more messages as a visual overlay on a geographic map (e.g., points on a map that are selectable to view message details), indicating the physical location(s) of the access point(s) from which each message originated. The message reporting interface may also present metadata associated with messages, such as meteorological data from one or more sensors, message timestamps, message priorities, etc. The message reporting interfaced may also indicate assets associated with different geographic locations, such as human assets, technology assets, vehicles, food and water, emergency resources, etc.

In an embodiment, the message reporting interface provides a clear operating picture of a complex situation. The message reporting interface may allow one or more users to visualize and understand a potentially complex set of events and/or needs occurring in the geographical region where the wide-area mesh network is deployed. The message reporting interface may not be limited to a single wide-area mesh network, but may be configured to provide real-time mapping and representation of active scenarios in a multitude of geographies. A user may be able to filter the messages and/or other data presented in the message reporting interface, to obtain a focused view of a particular set of data of interest to the user (e.g., medical needs, weather conditions, etc.). In general, using message data received from one or more access points, the message reporting interface may facilitate the timely identification and resolution of needs in a geographic region where a wide-area mesh network is deployed.

In an embodiment, the wide-area mesh network provides only for unidirectional messaging, from one or more access points to one or more endpoints. Alternatively, the message reporting interface may also include controls for sending messages to one or more user devices accessing the wide-area mesh network, via one or more access points (e.g., in a messaging interface presented by an access point, as described above). To transmit a message to a user device (Operation 326), a user prepares the message using a message reporting interface (e.g., a message reporting interface presented by an endpoint or external service). If the message reporting interface is part of an external service, then the external service transmits the message to the endpoint. The endpoint broadcasts the message over the wide-area mesh network, to be propagated to the access point. Repeaters that receive the message may decide whether to repeat the message, based on distance metrics as described above but with the opposite objective of ensuring that the message propagates away from the endpoint. When the access point receives the message, the access point presents the message to the user device, e.g., in a messaging interface in a captive portal.

### 4. Additional Examples

Detailed examples are described below for purposes of clarity. Components and/or operations described below should be understood as examples that may not be applicable to one or more embodiments. Accordingly, components and/or operations described below should not be construed as limiting the scope of one or more embodiments.

### 4.1. Overlapping Networks

In some cases, two or more networks using the same transmission technology (e.g., LoRa) may be operating in the same geographic region. Two networks may be the same kind of network (e.g., two wide-area mesh networks) or different kinds of networks (e.g., a wide-area mesh network and a point-to-point network). To protect network traffic from unauthorized access in a wide-area mesh network, and to avoid overloading the wide-area mesh network with traffic from another network, nodes in the wide-area mesh network may use one or more network keys to determine whether a received message belongs to the same network as the repeater.

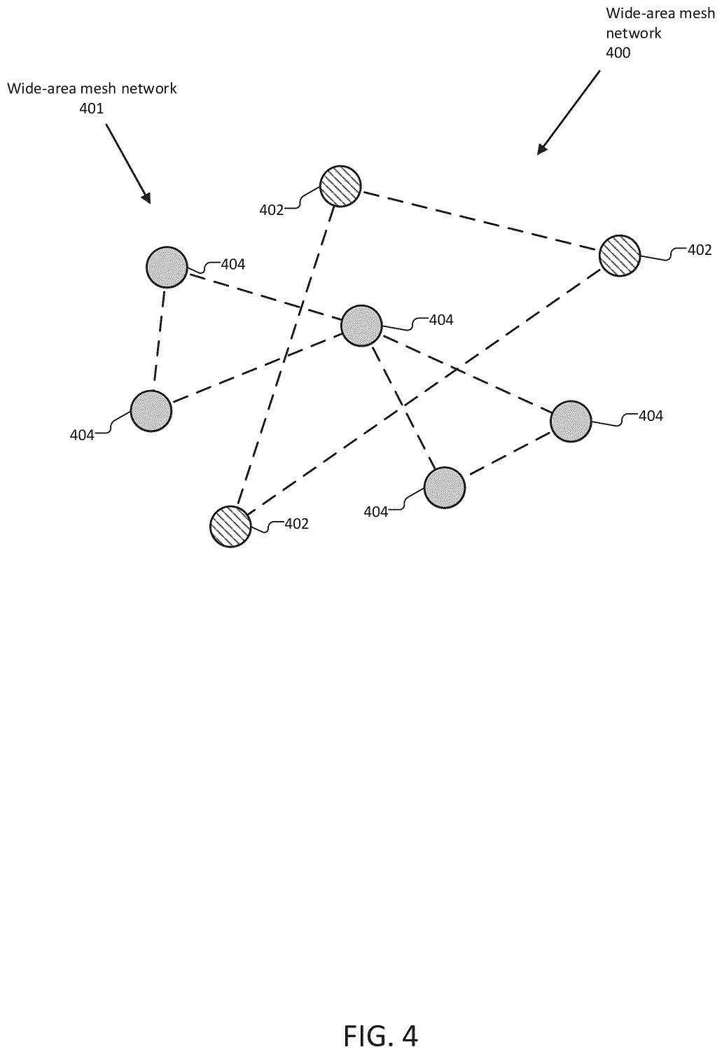

FIG. 4 is a block diagram of an example of overlapping networks according to an embodiment. In this example, the two networks are both wide-area mesh networks: one set of nodes 402 forms one wide-area mesh network 400, and another set of nodes 404 forms another wide-area mesh network 401. As illustrated in this example, the wide-area mesh networks 400, 401 are geographically overlapping, such that nodes 402 in wide-area mesh network 400 may receive messages that belong in wide-area mesh network 401, and nodes 404 in wide-area mesh network 401 may receive messages that belong in wide-area mesh network 400.

As described above, to help segregate traffic between the wide-area mesh networks 401, 400, a node that transmits a message may package the message with metadata that uniquely identifies the network to which the message belongs. For example, the metadata may include a keyword (e.g., “Network400,” “Network401”), an encryption key, and/or another form of metadata or combination thereof. Each node that is configured to receive a message may be configured to inspect the metadata, to determine whether the message belongs to the same network as the receiving node. For example, the receiving node may need to store a matching keyword or corresponding encryption key. If the message is not in the same network as the receiving node, then the receiving node may not expend the resources to propagate the message any further.

### 4.2. Bridging Network Segments

In some cases, one or more nodes in a wide-area mesh network may use a different kind of transmitter and/or receiver than one or more other nodes in the wide-area mesh network. For example, one node may be an older version of a repeater that uses a particular kind of transceiver, while another node may be a newer version of a repeater that uses a newer kind of transceiver. The two kinds of transmitters and/or receivers may not be cross-compatible. For example, the two kinds of transmitters and/or receivers may operate at different frequencies. In such cases, a wide-area mesh network may use a bridge device to allow for communication between the two different kinds of nodes. The bridge device allows for communication between two segments of the wide-area mesh network that are not directly compatible with each other.

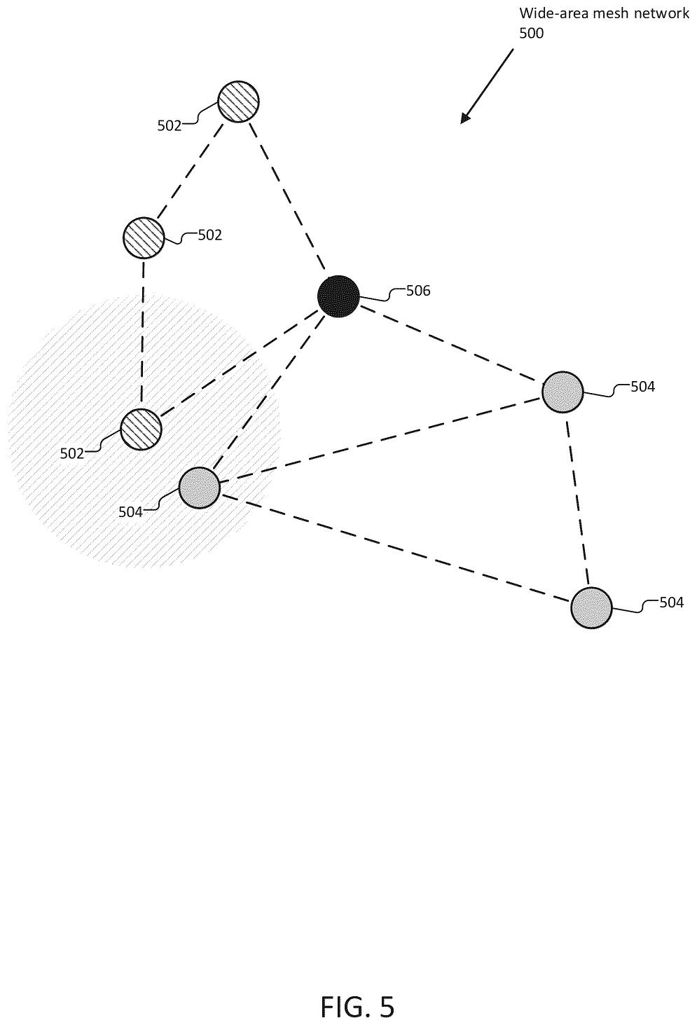

FIG. 5 is a block diagram of an example of bridging segments of a wide-area mesh network 500 according to an embodiment. As illustrated in FIG. 5, nodes 502 in one segment of the wide-area mesh network 500 are unable to communicate directly with nodes 504 in another segment of the wide-area mesh network 500, even when the nodes are within range of each other. A bridge device 506 is capable of communicating with both types of nodes. For example, the bridge device 506 may be a multi-antenna device including at least one transceiver that is configured to communicate with one kind of node 502, and at least one other transceiver that is configured to communicate with another kind of node 504. Adding a bridge device 506 may allow for greater flexibility in deployment of wide-area mesh networks, and may allow for the continued use of older nodes that might otherwise become obsolete.

### 4.3. Apparatus

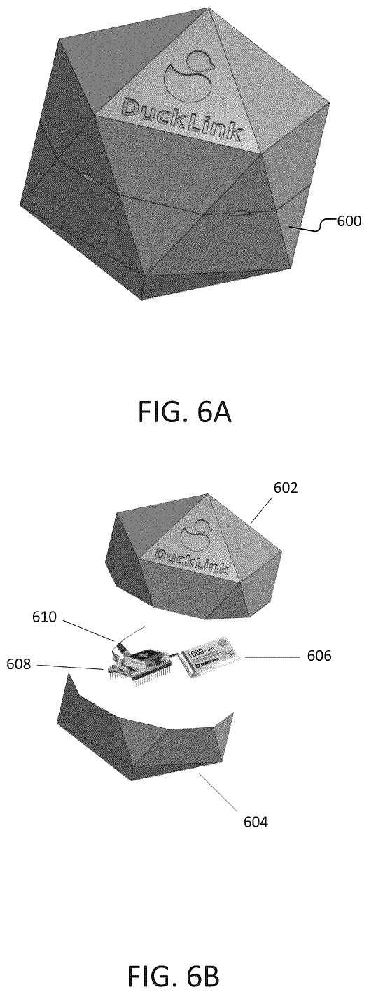

Nodes in a wide-area mesh network may take many different forms. FIGS. 6A-6B illustrate an example of an apparatus 600 according to an embodiment. Specifically, the apparatus 600 may be a deployable access point, repeater, and/or endpoint of a wide-area mesh network. As illustrated in FIGS. 6A, the apparatus 600 may include an enclosure that includes two or more segments 602, 604. The enclosure may be formed of plastic, metal, and/or another material or combination thereof. In some cases, the enclosure may have been printed using a 3-dimensional (3D) printer. The enclosure may be weather-resistant. The enclosure may be capable of being deployed from a drone, manned aircraft, or using another deployment technique, with or without a parachute (not shown). The segments 602, 604 of the enclosure may be configured to attach to each other using clips, glue, neodymium magnets, and/or another fastening/scaling mechanism or combination thereof. When the apparatus 600 is manufactured, digital electronics (examples of which described in further detail below) may be disposed within the enclosure. The apparatus 600 may be ready for deployment when the enclosure is closed. In an embodiment, any number of the apparatus 600 (e.g., dozens, hundreds, or more) may be deployed across a geographic region, to form a wide-area mesh network.

In an embodiment, digital electronics disposed within the apparatus 600 include a battery 606. The battery 606 may be configured to provide power to other components of the apparatus for some period of time. The size of the battery 606 may depend on design factors such as device life, size, shape (e.g., profile), and/or weight. Alternatively or additionally, the apparatus 600 may include one or more solar panels (not shown), disposed on an exterior surface of the apparatus 600. A battery 606 may be configured to store energy generated using a solar panel, to provide for independent power even when sunlight is not available.

In an embodiment, digital electronics disposed within the apparatus 600 include digital circuitry 608 and one or more antennas 610. The antenna(s) 610 is/are configured to send and/or receive signals over the wide-area mesh network. For example, an antenna 610 may be a Wi-Fi antenna, LoRa antenna, Bluetooth® antenna, or another kind of antenna. While the term “antenna” is used herein, wireless communication hardware included in the apparatus 600 may not have a typical “antenna” shape or form factor. For example, one or more segments 602, 604 of the apparatus 600 may be configured to operate as an antenna. If the apparatus 600 is an access point, the apparatus 600 may include two or more antennas that allow the apparatus 600 to communicate with both a user device (e.g., using Wi-Fi or Bluetooth®) and other nodes (e.g., using LoRa) in the wide-area mesh network. An antenna 610 may be configured to operate according one or more particular frequencies according to the standards of the country or region in which the apparatus 600 is deployed.

In an embodiment, digital electronics disposed within the apparatus 600 include digital circuitry 608. The digital circuitry 608 includes digital logic, implemented in hardware and/or software, to support wireless communication. For example, if the apparatus 600 is an access point, the digital circuitry 610 may include a web server configured to present a messaging interface as a web page in a captive portal. In general, in an embodiment, the digital circuitry 608 is configured to perform operations described above, depending on the kind of apparatus 600 (e.g., access point, repeater, and/or endpoint). In addition, the digital circuitry 608 may include hardware and/or software configured to manage power usage of the apparatus 600, e.g., power generated using a solar panel and/or stored or drawn from a battery 606. Power management may be configured to maximize a functional lifespan of the apparatus 600, when external power is not available.

In an embodiment, digital electronics disposed within the apparatus 600 include one or more environmental sensors (not shown). An environmental sensor may be configured to gather data such as GPS coordinates, environmental temperature, and/or environmental humidity. Data gathered by a sensor may be included in a message (e.g., packaged in metadata) transmitted to an endpoint, to provide additional information about the environment in which the apparatus 600 is deployed.

### 5. Miscellaneous

In an embodiment, a system includes one or more devices, including one or more hardware processors, that are configured to perform any of the operations described herein and/or recited in any of the claims.

In an embodiment, a non-transitory computer-readable storage medium stores instructions that, when executed by one or more hardware processors, cause performance of any of the operations described herein and/or recited in any of the claims.

Any combination of the features and functionalities described herein may be used in accordance with an embodiment. In the foregoing specification, embodiments have been described with reference to numerous specific details that may vary from implementation to implementation. Accordingly, the specification and figures are to be regarded in an illustrative rather than a restrictive sense. The sole and exclusive indicator of the scope of the invention, and what is intended by the Applicant to be the scope of the invention, is the literal and equivalent scope of the set of claims that issue from this application, in the specific form in which such claims issue, including any subsequent correction.

### 6. Computing Devices

In an embodiment, techniques described herein are implemented by one or more special-purpose computing devices (i.e., computing devices specially configured to perform certain functionality). The special-purpose computing device(s) may be hard-wired to perform the techniques and/or may include digital electronic devices such as one or more application-specific integrated circuits (ASICs), field programmable gate arrays (FPGAs), and/or network processing units (NPUs) that are persistently programmed to perform the techniques. Alternatively or additionally, a computing device may include one or more general-purpose hardware processors programmed to perform the techniques pursuant to program instructions in firmware, memory, and/or other storage. Alternatively or additionally, a special-purpose computing device may combine custom hard-wired logic, ASICs, FPGAs, or NPUs with custom programming to accomplish the techniques. A special-purpose computing device may include a desktop computer system, portable computer system, handheld device, networking device, and/or any other device(s) incorporating hard-wired and/or program logic to implement the techniques.

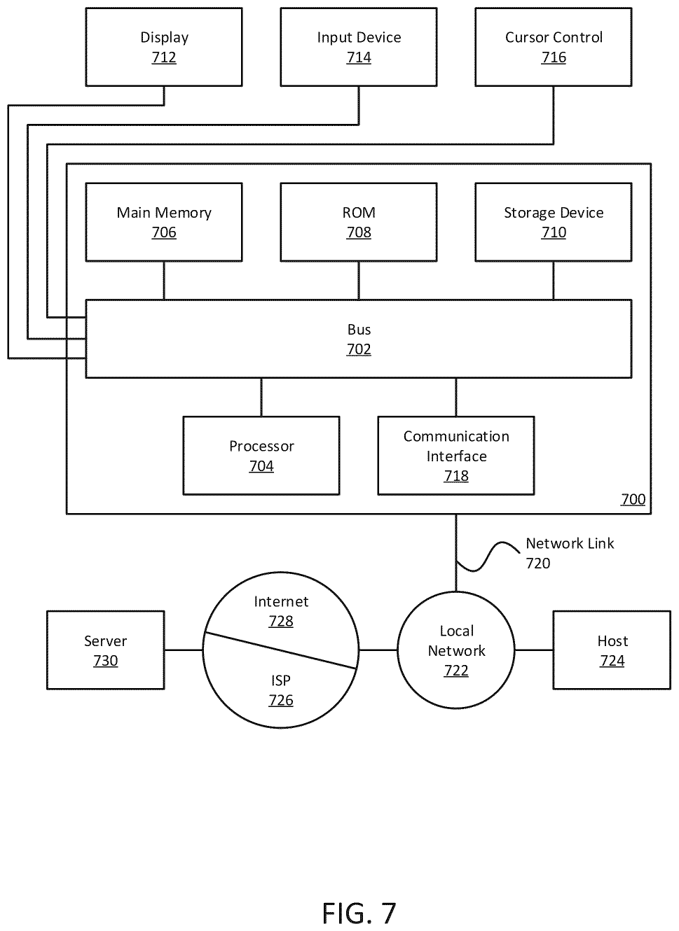

For example, FIG. 7 is a block diagram of an example of a computer system 700 according to an embodiment. Computer system 700 includes a bus 702 or other communication mechanism for communicating information, and a hardware processor 704 coupled with the bus 702 for processing information. Hardware processor 704 may be a general-purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in one or more non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a liquid crystal display (LCD), plasma display, electronic ink display, cathode ray tube (CRT) monitor, or any other kind of device for displaying information to a computer user. An input device 714, including alphanumeric and other keys, may be coupled to bus 702 for communicating information and command selections to processor 704. Alternatively or additionally, computer system 700 may receive user input via a cursor control 716, such as a mouse, a trackball, a trackpad, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. Alternatively or additionally, computer system 7 may include a touchscreen. Display 712 may be configured to receive user input via one or more pressure-sensitive sensors, multi-touch sensors, and/or gesture sensors. Alternatively or additionally, computer system 700 may receive user input via a microphone, video camera, and/or some other kind of user input device (not shown).

Computer system 700 may implement the techniques described herein using customized hard-wired logic, one or more ASICs or FPGAs, firmware, and/or program logic which in combination with other components of computer system 700 causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. Alternatively or additionally, hard-wired circuitry may be used in place of or in combination with software instructions.

The term “storage media” as used herein refers to one or more non-transitory media storing data and/or instructions that cause a machine to operate in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape or other magnetic data storage medium, a CD-ROM or any other optical data storage medium, any physical medium with patterns of holes, a RAM, a programmable read-only memory (PROM), an erasable PROM (EPROM), a FLASH-EPROM, non-volatile random-access memory (NVRAM), any other memory chip or cartridge, content-addressable memory (CAM), and ternary content-addressable memory (TCAM).

A storage medium is distinct from but may be used in conjunction with a transmission medium. Transmission media participate in transferring information between storage media. Examples of transmission media include coaxial cables, copper wire, and fiber optics, including the wires that comprise bus 702. Transmission media may also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer may load the instructions into its dynamic memory and send the instructions over a network, via a network interface controller (NIC), such as an Ethernet controller or Wi-Fi controller. A NIC local to computer system 700 may receive the data from the network and place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722, and communication interface 718.

The received code may be executed by processor 704 as it is received, and/or stored in storage device 710, or other non-volatile storage for later execution.

### 7. Computer Networks

In an embodiment, a computer network provides connectivity among a set of nodes running software that utilizes techniques as described herein. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (for example, a request to execute a particular application and/or retrieve a particular set of data). A server process responds by executing the requested service and/or returning corresponding data.

A computer network may be a physical network, including physical nodes connected by physical links. A physical node is any digital device. A physical node may be a function-specific hardware device. Examples of function-specific hardware devices include a hardware switch, a hardware router, a hardware firewall, and a hardware NAT. Alternatively or additionally, a physical node may be any physical resource that provides compute power to perform a task, such as one that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (for example, a physical network). Each node in an overlay network corresponds to a respective node in the underlying network. Accordingly, each node in an overlay network is associated with both an overlay address (to address the overlay node) and an underlay address (to address the underlay node that implements the overlay node). An overlay node may be a digital device and/or a software process (for example, a virtual machine, an application instance, or a thread). A link that connects overlay nodes may be implemented as a tunnel through the underlying network. The overlay nodes at either end of the tunnel may treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources may be shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, a system supports multiple tenants. A tenant is a corporation, organization, enterprise, business unit, employee, or other entity that accesses a shared computing resource (for example, a computing resource shared in a public cloud). One tenant (through operation, tenant-specific practices, employees, and/or identification to the external world) may be separate from another tenant. The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In an embodiment, in a multi-tenant computer network, tenant isolation is implemented to ensure that the applications and/or data of different tenants are not shared with each other. Various tenant isolation approaches may be used. In an embodiment, each tenant is associated with a tenant ID. Applications implemented by the computer network are tagged with tenant ID's. Additionally or alternatively, data structures and/or datasets, stored by the computer network, are tagged with tenant ID's. A tenant is permitted access to a particular application, data structure, and/or dataset only if the tenant and the particular application, data structure, and/or dataset are associated with a same tenant ID. As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants. A subscription list may indicate which tenants have authorization to access which applications. For each application, a list of tenant ID's of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels may be used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

What is claimed is:

1. A method comprising:
receiving, by an access point in a wide-area mesh network, a connection request from a user device;
responsive to the connection request, presenting a messaging interface in a captive portal to the user device;
receiving, by the access point via the messaging interface in the captive portal, a message to be transmitted over the wide-area mesh network;
transmitting the message from the access point to an endpoint in the wide-area mesh network, via one or more wide-area repeaters in the wide-area mesh network; and
subsequent to transmitting the message from the access point to the endpoint in the wide-area mesh network, presenting the message in a message reporting interface.

2. The method of claim 1, further comprising:
transmitting the message from the endpoint in the wide-area mesh network to a device that is operating outside the wide-area mesh network and configured to display the message reporting interface.

3. The method of claim 1, further comprising:
transmitting a response to the message from the endpoint to the access point; and
presenting the response to the message in the messaging interface in the captive portal.

4. The method of claim 1, wherein transmitting the message from the access point to the endpoint in the wide-area mesh network comprises:
broadcasting the message from the access point to at least a first wide-area repeater and a second wide-area repeater;
repeating the message over the wide-area mesh network, by the first wide-area repeater, based on a determination that a distance from the first wide-area repeater to the endpoint is not greater than a distance from the access point to the endpoint; and
refraining from repeating the message over the wide-area mesh network, by the second wide-area repeater, based on a determination that a distance from the second wide-area repeater to the endpoint is greater than the distance from the access point to the endpoint.

5. The method of claim 1, wherein transmitting the message from the access point to the endpoint in the wide-area mesh network comprises:
broadcasting the message a first time from the access point over the wide-area mesh network;
subsequent to broadcasting the message the first time, waiting a random or pseudorandom time interval; and
subsequent to waiting the random or pseudorandom time interval, broadcasting the message a second time from the access point over the wide-area mesh network.

6. The method of claim 1, further comprising:
performing, by the access point, a text substitution to reduce a character length of the message, to reduce a number of packets needed to transmit the message without any loss of semantic meaning.

7. The method of claim 1, further comprising:
deploying the access point from an aircraft into a physical region comprising the wide-area mesh network.

8. The method of claim 1, wherein the messaging interface comprises a plurality of predetermined selectable messages associated with an operational purpose of the wide-area mesh network.

9. The method of claim 8, wherein the operational purpose is disaster relief and the plurality of predetermined selectable messages comprises at least one emergency request.

10. The method of claim 1, wherein presenting the messaging interface in the captive portal comprises serving, by the access point, the messaging interface to the user device as a web page without requiring a user of the user device to specify a uniform resource locator (URL) of the web page.

11. The method of claim 1, further comprising:
segregating network traffic in the wide-area mesh network from other wide-area network traffic, at least by associating packets in the wide-area mesh network with a network key that is unique to the wide-area mesh network.

12. One or more non-transitory machine-readable media storing instructions that, when executed by the one or more processors, cause:
receiving, by an access point in a wide-area mesh network, a connection request from a user device;
responsive to the connection request, presenting a messaging interface in a captive portal to the user device;
receiving, by the access point via the messaging interface in the captive portal, a message to be transmitted over the wide-area mesh network; and
transmitting the message from the access point to an endpoint in the wide-area mesh network, via one or more wide-area repeaters in the wide-area mesh network, for presentation in a message reporting interface.

13. The one or more non-transitory machine-readable media of claim 12, further storing instructions that, when executed by one or more processors, cause:
receive a response to the message from the endpoint; and
presenting the response in the messaging interface in the captive portal.

14. The one or more non-transitory machine-readable media of claim 12, further storing instructions that, when executed by one or more processors, cause:
receiving a network configuration message from the endpoint over the wide-area mesh network; and
based at least on the network configuration message, determining a distance from the access point to the endpoint,
wherein transmitting the message from the access point to the endpoint in the wide-area mesh network comprises broadcasting at least one data packet comprising the message and the distance from the access point to the endpoint.

15. The one or more non-transitory machine-readable media of claim 12, wherein transmitting the message from the access point to the endpoint in the wide-area mesh network comprises:
broadcasting the message a first time from the access point over the wide-area mesh network;
subsequent to broadcasting the message the first time, waiting a random or pseudorandom time interval; and
subsequent to waiting the random or pseudorandom time interval, broadcasting the message a second time from the access point over the wide-area mesh network.

16. The one or more non-transitory machine-readable media of claim 12, wherein presenting the messaging interface in the captive portal comprises serving, by the access point, the messaging interface to the user device as a web page without requiring a user of the user device to specify a uniform resource locator (URL) of the web page.

17. The one or more non-transitory machine-readable media of claim 12, further storing instructions that, when executed by one or more processors, cause:
segregating network traffic in the wide-area mesh network from other wide-area network traffic, at least by associating packets in the wide-area mesh network with a network key that is unique to the wide-area mesh network.

18. A system comprising:
an endpoint in a wide-area mesh network;
one or more wide-area repeaters in the wide-area mesh network; and
an access point in the wide-area mesh network, configured to:
receive a connection request from a user device,
responsive to the connection request, present a messaging interface in a captive portal to the user device,
receive, via the messaging interface in the captive portal, a message to be transmitted over the wide-area mesh network, and
transmit the message from the access point to the endpoint in the wide-area mesh network, via the one or more wide-area repeaters in the wide-area mesh network, for presentation in a message reporting interface.

19. The system of claim 18, further comprising:
a device that is operating outside the wide-area mesh network and configured to display the message reporting interface,
the endpoint in the wide-area mesh network being configured to transmit the device that is operating outside the wide-area mesh network.

20. The system of claim 18, wherein the one or more wide-area repeaters comprises a plurality of wide-area repeaters configured to communicate using long-range (LoRa) transceivers.
